(19) United States
(12) Patent Application Publication
(10) Pub. No.: US 2016/0100036 A1
(43) Pub. Date: Apr. 7, 2016

(54) SYSTEM, METHOD, SERVER AND DEVICE FOR TRIAL USE OF APPLICATION SOFTWARE

(71) Applicant: VMFive Inc., Grand Cayman (KY)

(72) Inventors: Yin-Tsung LO, Taipei City (TW); Jiun-Hung DING, Taipei City (TW); Hsu-En LEE, Taipei City (TW)

(21) Appl. No.: 14/876,161

(22) Filed: Oct. 6, 2015

(30) Foreign Application Priority Data
Oct. 6, 2014 (TW) 103134817

(51) Int. Cl. H04L 29/06; G06F 9/455; H04L 29/08

(52) U.S. Cl. CPC H04L 67/42; H04L 67/08; G06F 9/45558; G06F 2009/45595

(57) ABSTRACT

A system for trial use of application software comprises at least one user device and a server. The server is communicatively coupled to the user device. The server receives a request data for trying an application software, the request data is generated corresponding to an input on the user device, the server executes at least one part of the application software according to the request data and establishes a two-way communication with the user device, and the server and the user device transmits at least one image data and at least one control data via the two-way communication.

### CROSS REFERENCE TO RELATED APPLICATIONS

This Non-provisional application claims priority under 35 U.S.C. §119(a) on Patent Application No(s). 103134817 filed in Taiwan, Republic of China on Oct. 6, 2014, the entire contents of which are hereby incorporated by reference.

### BACKGROUND

1. Technical Field

The invention relates to a system, method, server and device for trial use of application software.

2. Related Art

As smart phones and tablet computers become popular, the mobile application (abbreviated to mobile app or app) for these mobile user devices also grow flourish. Users can download these software applications for the mobile user devices from the application store (for example Google play or APP store of Apple) and then install and execute them. It is convenient and prompt so as to satisfy various needs of users.

However, the current application stores only provide users with static text descriptions, figures or videos for reference before purchasing. The user has no choice but to riskily pays for the application and then downloads and installs it if he needs to check whether the application meets his need. On the other hand, some users give up because they are afraid that the purchased application does not meet their actual needs.

To overcome this problem, some companies provide free trials for users. Although the user can use the free trial first, it is inevitable that download, installation or complicated steps are still necessary. Furthermore, additional manual deletion is required if the user is not satisfied with the software. These operations are boring and waste the storage and computing resources of the device.

Therefore, a system, a method, a server and a user device for trial use of application software are needed where trial use is done on the user's own device but it is not necessary for the user to download and install the application software or even the trail software. In such manner, its cost is reduced and even it is free, and the hardware resource avoids unnecessary waste. Besides, unnecessary operation steps and download time are also reduced. Accordingly, the user may be more possibly willing to try, and advertisement or sell may contribute to better results.

### SUMMARY

An aspect of the disclosure provides a system, method, server and user device for trial use of application software. Trial use is done on the user's own device but it is not necessary for the user to download and install the application software or even the trail software. Thus, its cost is reduced and even it is free, and the hardware resource avoids unnecessary waste. Besides, unnecessary operation steps and download time are also reduced. Accordingly, the user may be more possibly willing to try, and advertisement or sell may contribute to better results.

A system for trial use of application software comprises at least one user device and a server. The server is communicatively coupled to the user device. The server receives a request data for trying an application software, the request data is generated corresponding to an input on the user device, the server executes at least one part of the application software according to the request data and establishes a two-way communication with the user device, and the server and the user device transmits at least one image data and at least one control data via the two-way communication.

In an embodiment, the server comprises at least one cluster computing unit, the cluster computing unit comprises at least one cluster node, and the server executes the application software by the cluster node.

In an embodiment, the cluster node comprises at least one virtual machine, and the server executes the application software by the virtual machine.

In an embodiment, the virtual machine executes an operating system corresponding to the application software, and executes the application software on the operating system.

In an embodiment, the cluster node comprises a plurality of virtual machines respectively to execute different operating systems.

In an embodiment, the system further comprises another user device. the server receives another request data for trying another application software, another request data is generated corresponding to an input on another user device, and the server executes another application software on the same virtual machine according to another request data.

In an embodiment, the virtual machine executes an I/O agent to transfer data to the user device via the two-way communication.

In an embodiment, the number of the I/O agent executed by the virtual machine is equal to the number of the application software executed by the virtual machine.

In an embodiment, the server comprises a memory unit storing a snapshot data of which the state is that the server executes the application software.

In an embodiment, the server executes the application software according to the snapshot data.

In an embodiment, the server comprises an application program interface unit, a service session manager and a resource pool manager, the application program interface unit receives the request data, the service session manager generates a service session data according to the request data, the resource pool manager obtains/generates a data related to the execution of the application software according to the service session data, and the server executes the application software according to the data related to the execution of the application software.

A server is applied to a system for trial use of application software. The system comprises the server and at least one user device. The server is communicatively coupled to the user device. The server comprises at least one memory unit, at least one transmitting unit and one or more than one computing unit. The computing unit is respectively communicatively coupled to the memory unit and the transmitting unit, the transmitting unit receives a request data, the request data is generated corresponding to an input on the user device, the computing unit executes at least one part of the application software stored in the memory unit according to the request data and establishes a two-way communication with the user device by the transmitting unit, and the server and the user device transfer at least one image data and at least one control data via the two-way communication.

In an embodiment, the server further comprises at least one cluster computing unit, the cluster computing unit comprises at least one cluster node, and the server executes the application software by the cluster node.

In an embodiment, the cluster node comprises at least one virtual machine, and the server executes the application software by the virtual machine.

In an embodiment, the virtual machine executes an operating system corresponding to the application software, and executes the application software on the operating system.

In an embodiment, the cluster node comprises a plurality of virtual machines respectively to execute different operating systems.

In an embodiment, the server receives another request data for trying another application software, another request data is generated corresponding to an input on another user device, and the server executes another application software on the same virtual machine according to another request data.

In an embodiment, the virtual machine executes an I/O agent to transfer data to the user device via the two-way communication.

In an embodiment, the number of the I/O agent executed by the virtual machine is equal to the number of the application software executed by the virtual machine.

In an embodiment, the memory unit stores a snapshot data of which the state is that the server executes the application software.

In an embodiment, the server executes the application software according to the snapshot data.

In an embodiment, the server further comprises an application program interface unit, a service session manager and a resource pool manager, the application program interface unit receives the request data, the service session manager generates a service session data according to the request data, the resource pool manager obtains/generates a data related to the execution of the application software according to the service session data, and the server executes the application software according to the data related to the execution of the application software.

A user device is applied to a system for trial use of application software. The system for trial use of application software comprises a server and the user device. The server is communicatively coupled to the user device. The user device comprises at least one memory unit and one or more than one computing unit. The memory unit coupled to one or more than one computing unit stores a plurality of instructions. The computing unit executes the instructions for: receiving an input; sending a request data for trying an application software to the server according to the input; establishing a two-way communication with the server; and transferring at least one image data and at least one control data via the two-way communication with the server. The image data is generated by the server executing one part of the application software, and the control data is provided for the interaction with the application software.

In an embodiment, the server confirms the trial environment of the user device before executing at least one part of the application software.

In an embodiment, the server confirms the state of the stored application software before executing at least one part of the application software.

In an embodiment, the computing unit executes the instructions for loading an application software download data after the transfer of the image data is ended.

A method of trying application software is applied to a system for trial use of application software. The system comprises at least one user device and a server, and the server is communicatively coupled to the user device. The method comprises: generating a request data corresponding to an input by the user device for trying an application software; receiving the request data by the server; executing at least one part of the application software by the server according to the request data; establishing a two-way communication by the server and the user device; and transferring at least one image data and at least one control data via the two-way communication by the server and the user device.

In an embodiment, the method comprises: loading an application software download data by the user device after the transfer of the image data is ended.

As mentioned above, as to the system, the method, the server, the user device for trial use of application software, because the application software is executed on the server and it with the user device transfer the screen image and the control action via network, trial use is done on the user's own device under the condition that it is not necessary for the user to download or install the application software or even the trail software. Thus, the doubt about cost is solved, and the hardware resource avoids unnecessary waste. Because download or installation are not necessary and unnecessary operation steps and download time are also reduced, the trial manner of the disclosure is better than traditional trial software. Accordingly, the user may be more possibly willing to try, and advertisement or sell may contribute to better results.

In addition, since the application software is executed on the server, trial use is smoothly done by the user without the hardware limitation of the user device. For example, as to the major application software such as game software which generally requires high performance hardware, this topic is solved by the disclosure.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a schematic diagram showing the system for trial use of application software according to an embodiment;

FIG. 2 is a schematic diagram showing the server in FIG;

FIG. 3 shows another example of the server in FIG. 1;

FIG. 4 is a schematic diagram showing the server of the system for trial use of application software according to another embodiment;

FIG. 5 to FIG. 8 are schematic situation diagrams according to embodiments; and

FIG. 9 is a flow chart of the method of trying application software according to an embodiment.

### DETAILED DESCRIPTION OF THE INVENTION

The embodiments of the invention will be apparent from the following detailed description, which proceeds with reference to the accompanying drawings, wherein the same references relate to the same elements.

The application software referred in the following embodiments includes various software or programs for a certain purpose or use for the user. They are for example but not limited to mobile application (abbreviated as mobile app or app or called mobile application program) or computer executable program.

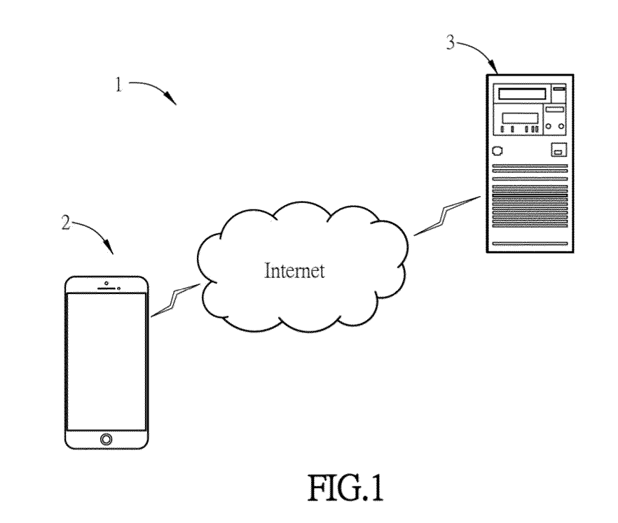

FIG. 1 is a schematic diagram showing the system for trial use of application software according to an embodiment. Referring to FIG. 1, in the embodiment, the system for trial use of application software 1 comprises a user device 2 and a server 3. For example, it comprises a plurality of the user devices 2. The user device 2 may be a smart phone, a tablet computer, a person digital assist, a camcorder capable of accessing Internet, a wearable device, a desktop computer, a notebook computer or any device capable of accessing Internet. In the embodiment, the user device 2 is a smart phone for example communicatively coupled to the server 3 via Internet by wireless communication.

When the user performs an input action on the user device 2 for example touching an icon or object related to the trial use of the application software, the user device 2 correspondingly generates a request data for trying the application software and sends the request data to the server 3.

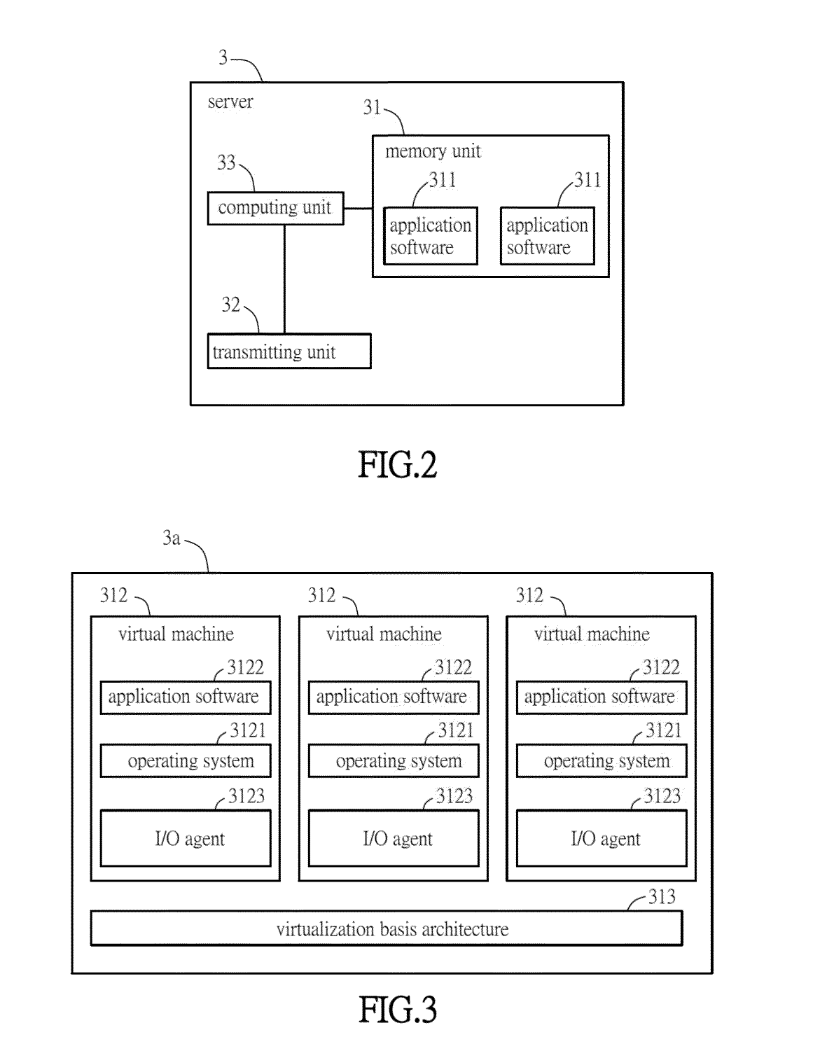

In the embodiment, the server 3 is a single physical host. FIG. 2 is a schematic diagram showing the server in FIG. Referring to FIG. 2, the server 3 comprises at least one memory unit 31, at least one transmitting unit 32 and a computing unit 33. In other examples, the server 3 may also comprises a plurality of the computing units to enhance computing efficiency. The server 3 receives the request data by the transmitting unit 32, and executes at least one part of the corresponding application software 311 according to the request data by the computing unit 33. The application software 311 is uploaded beforehand and stored in the memory unit 31. For example, various different sets of application software 311 stored in the memory unit 31 originate from different application software developers or advertisers and they can be tried by the user.

In the embodiment, executing at least one part of the application software 311 may refer to executing a segment of the whole content of the application software 311. For example, the application software 311 is a game software has 10 stages in its content, one part such as the content of the third stage is executed. In other embodiments, executing one part may refer to executing one part of the function of the application software. The server 3 may execute all the application software 311 for the user to try the application software completely at one time, either.

The computing unit 33 controls the transmitting unit 32 and the user device 2 to establish a two-way communication according to the content of the request data. For example, the transmitting unit 32 may establish the two-way communication with the user device 2 by Websocket communication protocol. In addition to Websocket communication protocol, other implementation manners also include communication by UDP, TCP, or other media transfer protocol based on UDP or TCP such as RTP, RTMP, RTSP, etc. Via the two-way communication, the user device 2 and the server 3 can exchange real-time data. Thus, the image data generated by the application software 311 executed on the server 3 can be transmitted to the user device 2 for displaying. The input control generated on the user device 2 by the user may be taken in the form of the control data and transferred to the server 3. The input control may be for example but not limited to touch input or voice input. Since the application software 311 is executed on the server 3, the user device 2 only needs to receive the screen image and send the input action, which acts as the input instruction to the application software 311, back to the server 3. Therefore, at the user device, the user can try the application software 311 under the condition that no download or installation of the application software 311 is done.

Transferred data between the two-way communication may include various kinds of data such as stereo data generated by the application software or sense result by the sensor of the user device 2 so that the user may possibly feel that he is really using the application software. For example, the data which are possibly transferred may further include Bluetooth signals, action sensing signals by three dimensional accelerormeter or gyroscope or the like, input signals of microphone voice or image signals captured by camera.

As to the image data, it may have at least two different styles. As to the first style, the image data is the content of the framebuffer. The content is one or more than one image rendered by the server 3. The transfer of the content of the framebuffer may be implemented by directly sending the image or by coding and streaming that namely the image is encoded by the server 3 and then sent to and decoded by the user device 2. As to the second style, the image data may be graphic instructions which are sent from the server 3 to the user device 2. After receiving the graphic instructions, the user device 2 renders and displays the image. These transmission manners may also be applied to other data transferred between the server 3 and the user device 2 for example stereo data.

Because the user device 2 may display a screen image after receiving the image data and the input action on the screen image triggers a corresponding function or result. For example, if a directory icon on the screen image is touched, a list composed of multiple items is called and displayed. Therefore, the system forms an interactive image interface on the user device 2 which is distinct from ordinary merely played video.

FIG. 3 shows another example of the server in FIG. 1. In the embodiment, the server 3a has similar hardware architecture including the memory unit, the transmitting unit and the computing unit. But it further distributes the resources of the memory unit and the computing unit to accordingly form a plurality of the virtual machine 312 (there are three in FIG. 3 for example). Each virtual machine 312 utilizes one part of the resource of the computing unit and executes the operating system 3121 stored in the memory unit. Accordingly, the application software 3122 which is designated to try in the environment of the operating system 3121 is executed. The operating system 3121 has a corresponding relationship with the application software 3122 for trial use. For example, if the application software 3122 is Android version, the virtual machine 312 should provide Android operation environment during operating; if the application software 3122 is iOS version, the virtual machine 312 should provide iOS operation environment during operating. Besides, the virtual machine 312 also executes an I/O agent 3123 (Input/Output agent) to transfer data to the transmitting unit 32 (please also refer to FIG. 2) and vice versa. Thus, the transmitting unit 32 and the user device 2 (please also refer to FIG. 1) are able to exchange data. In the embodiment, the number of the I/O agent 3123 executed by each virtual machine 312 is equal to the number of the application software 3122 executed by the same corresponding virtual machine 312, and they match correspondingly. For example, if one virtual machine 312 is designated to execute two sets of the application software 3122, it needs to execute two I/O agents 3123. Accordingly, data exchange between the user device 2 and the virtual machine 312 of the server 3a will not be confused. Thus, a single virtual machine 312 can execute multiple sets of the application software 3122 for multitasking and improving efficiency of resource utilization.

Referring to FIG. 3, the server 3a may run a virtualization basis architecture 313 which virtualizes hardware resources so multiple virtual machines 312 can share the physical hardware resources. Thus, it can act as a platform on which each virtual machine 312 operates and multiple virtual machines 312 can communicate or exchange data so as to overcome the integration barrier due to individual independent operating. In the embodiment, the virtualization basis architecture 313 is a software based on kernel-based virtual machine or similars, and it virtualizes the computing unit, the memory unit, and other hardware resources of the server 3a. In other embodiments, utilizing Xen or VMware or other similar software may implement the virtualization basis architecture, too. The virtualization basis architecture is not limited thereto.

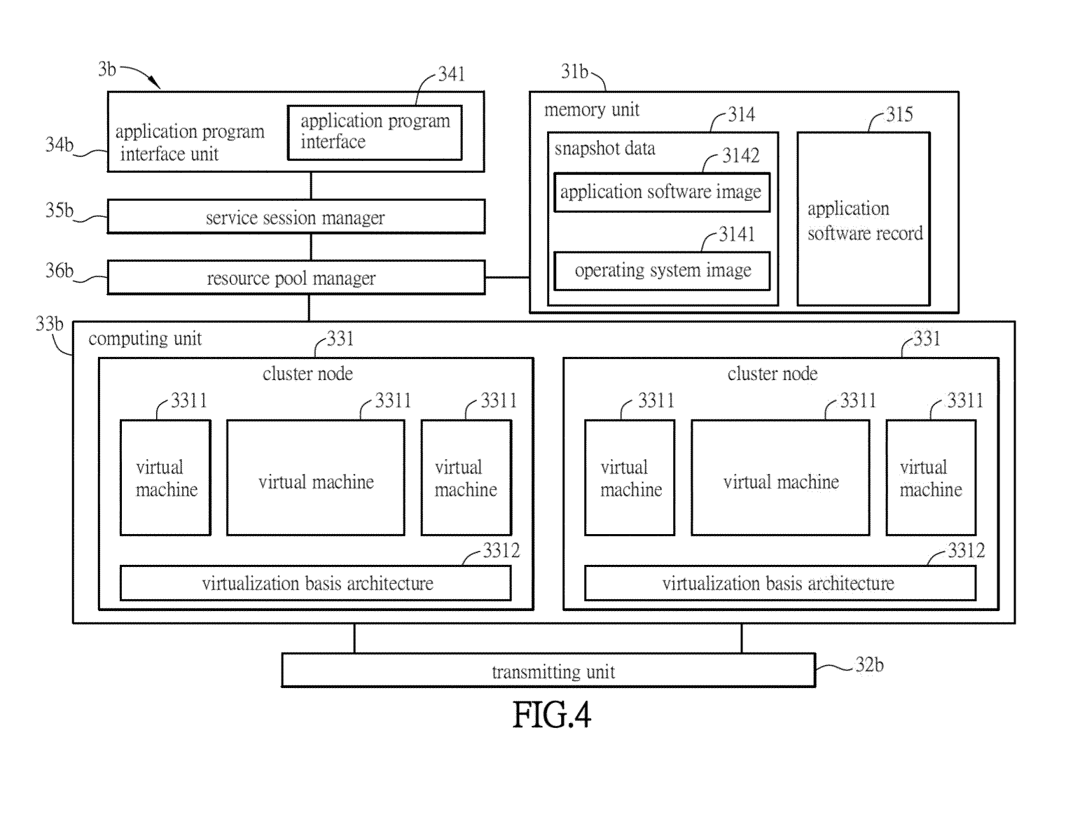

FIG. 4 is a schematic diagram showing the server of the system for trial use of application software according to another embodiment. Referring to FIG. 4, in the embodiment, a plurality of physical hosts communicatively coupled to each other by network communication protocol form the server 3b for efficiently utilizing the resources. The server 3b includes an application program interface unit 34b (or called API server), a service session manager 35b, a resource pool manager 36b, at least one computing unit 33b, at least one memory unit 3 lb and a transmitting unit 32b. These units and the physical hosts may match in various ways and they are communicatively coupled to each other via network protocol to individually perform a designate function. For example, the application program interface unit 34b, the service session manager 35b and the resource pool manager 36b are configured at one physical host, and the computing unit 33b is composed of a plurality of physical hosts. Since the computing unit 33b includes multiple physical hosts, the computing unit 33b in the embodiment is also called the cluster computing unit and its physical host each is called the cluster node 331. Alternatively in other embodiment, each unit mentioned above may also be an independent physical host, but it is not limited thereto.

The application program interface unit 34b executes the application program interface 341 matching an application program which is executed by the user device 2 (referring to FIG. 1) and configured to be triggered by touch to send a request for a trail use (API v.s. app). Thus, the server 3b may receive the request data, which is sent from the user device 2 by the application program, by the application program interface unit 34b.

The request data is transmitted to the service session manager 35b. The service session manager 35b handle the operating information about the server 3b which may include the interpretation of the content of the request data, the confirmation of the application software state, the information orientation, the time management of the application software execution and the management of connection status, etc. The service session manager 35b analyzes the content of the request data to generate a service session data, and utilizes the service session data to query the resource pool manager 36b about the status of the preparation for executing the application software. If the status is abnormal, an exceptional message is returned to the user device 2 and the resource pool manager 36b rearranges the resources and the computing unit 33b restores the application program; if the status is normal, the service session manager 35b utilizes the service session data to inform the resource pool manager 36b to assign one cluster node 331 of at least one computing unit 33b, the resource pool manager 36b generates a data related to the execution of the application software according to the service session data and accordingly asks the cluster node 331 to execute the application software. The service session data or the data related to the execution of the application software mentioned above may be a command instruction or a group of command instructions.

In the embodiment, the manner of executing the application software by the cluster node 331 can refer to the examples of the server 3, 3a in the previous embodiment. Namely, it may be implemented by directly utilizing the hardware resources to execute the application software or by the virtual machine. Here, the virtual machine is just illustrated for example but the implementation is not limited thereto. Because the implementation may refer to the previous descriptions, it is not repeated here.

In the embodiment, the memory unit 31b of the server 3b is an independent physical host, and the memory unit 31b stores a snapshot data (snapshot data) 314. The snapshot data 314 is an image data that the virtual machine 3311 has executed the application software in advance and then a system snapshot is taken at a certain or designate time point before the server 3b is requested to provide the trial use of the application software. The snapshot data 314 includes an operating system image (OS image) 3141 and an application software image (application software image) 3142. Besides, the memory unit 31b may also store an application software record 315 to record the execution history of the application software before requested to try the application software.

Accordingly, the developer of the application software or the manager of the server may upload the application software beforehand and store it in the memory unit 31b, and utilize the virtual machine 3311 to execute the application software. As soon as the execution of the virtual machine 3311 reaches the starting point of the trial use which is set for the user by the developer or the manager of the server, a snapshot is taken and the generated snapshot data 314 is then stored. Thus, when the cluster node 331 is going to generate the virtual machine 3311 for executing the application software on the virtualization basis architecture 3312, the resource pool manager 36b instructs the cluster node 331 to retrieve a designate snapshot data 314 in the memory unit 31b. As a result, the trial use can begin at the starting point designated by the developer or the manager of the server instead of from scratch so the trial use become more friendly to the user. Furthermore, the service session manager 35b is able to handle the operating time of the computing unit 33b, so it can set the trial time period for the designate application software and accordingly set the end point of the trial use of the application software.

In the embodiment, the transmitting unit 32b is a transmission gateway which takes charge of the task assigned by the service session manager 35b to establish the two-way communication with the user device 2 after the service session manager 35b determines that the application software is ready to run. The generated image data and various input/output for example including the input data of the user can be exchanged between the server 3b and the user device 2. Since the transmitting unit 32b is able to perform this function, it is also called the input/output gateway (I/O gateway). The way to establish the two-way communication between the transmitting unit 32b and the user device 2 may be implemented by Websocket communication protocol, UDP, TCP, or other media transfer protocol based on UDP or TCP such as RTSP, etc., and it is not limited thereto. Because the implementation of the transmitting unit 32b by one or more than one physical host or the implementation details of the communication protocol should be understood by the skill person in the art, they are not repeated here.

If the two-way communication is established, the subsequent trial use can refer to the previous description after the server 3b executes the application software by the cluster node 331.

In the embodiment, the server 3b may concurrently receive a plurality of different request data of the user devices 2. Each request data may request to try different application software. However, as long as sets of the application software are executed in the same environment of the operating system, the cluster node 331 may utilize the same one virtual machine 3311 to concurrently execute them multitasking and saving resources. In other words, one virtual machine 3311 is able to run one operating system and execute two or more than two different application programs in the environment of the operating system.

In an embodiment, a development board may be utilized as the core operating in the server so it is more convenient and flexible to integrate or collocate various or different hardware devices.

As to the explanation of the implementation, the following description illustrates that one user uses the user device to send a request for trial use. The cooperating system can refer to FIG. 1 and FIG. 4.

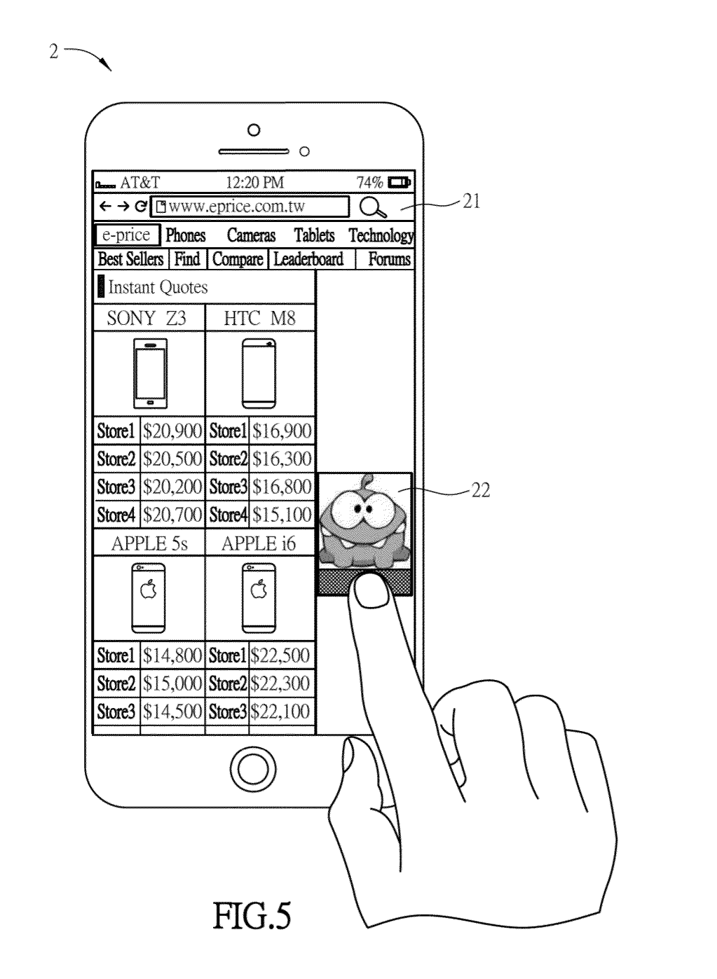

FIG. 5 is a schematic situation diagram according to an embodiment. Referring to FIG. 5, when the user operates the user device 2 and uses the browser 21, the page of the browser 21 displays an advertisement object 22 which sells an application software to the user. As soon as the user touches (for example taps, clicks, etc.) the advertisement object 22, the user device 2 sends the request data to the server 3b (please also refer to FIG. 4). The application program interface unit 34b of the server 3b receives the request data and sends the request data to the service session manager 35b. The service session manager 35b checks the status of the application program by the resource pool manager 36b, and instructs the resource pool manager 36b to allocate one virtual machine 3311 to execute the application software if the status is normal. The virtual machine 3311 is prepared and ready before the server 3b receives the request data. For example, the virtual machine 3311 is mounted with the snapshot data 314 (including the operating system image 3141 and the application software image 3142) beforehand and thus it is able to execute the application software at any time. For example, the service session manager 35b may be configured to instruct the cluster node 331 to produce a plurality of the virtual machines 3311 in advance according to the setting.

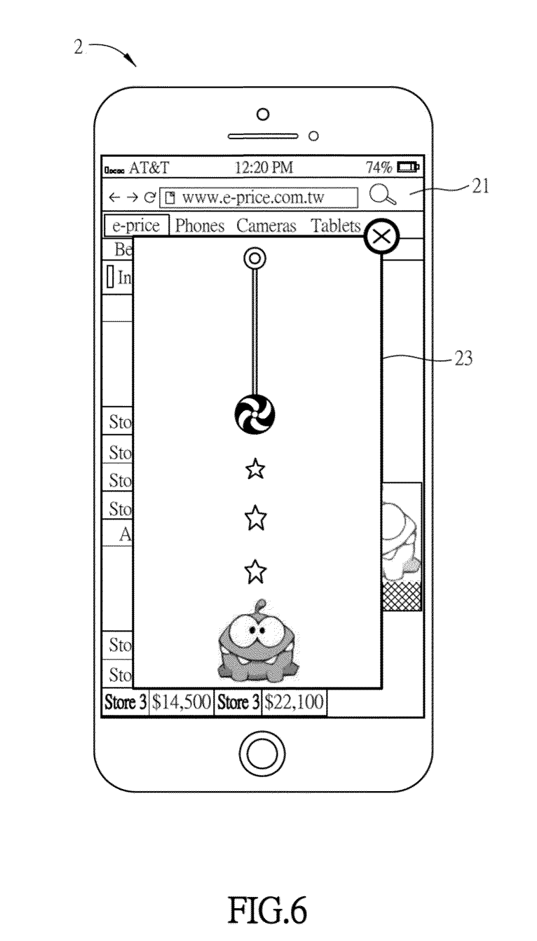

In addition, the service session manager 35b also analyzes a location data of the user device 2 carried in the request data, and assign the transmitting unit 32b to establish the two-way communication with the user device 2. After the two-way communication is established, the image data and the stereo data generated by the application software can be transferred to the user device 2 by real time streaming and then displayed as an interactive graphical interface 23 as shown in FIG. 6 which is a schematic situation diagram according to an embodiment.

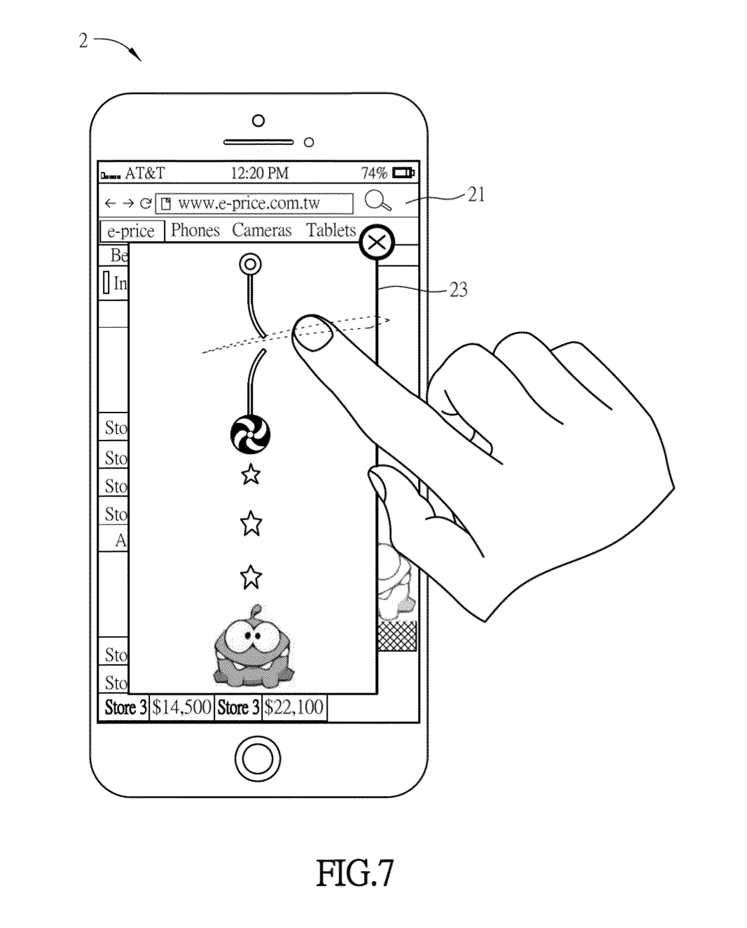

Via the two-way communication, the input action of the user on the user device 2 may be also sent as a feedback to the virtual machine 3311 so as to effect a designate or corresponding input result. FIG. 7 is a schematic situation diagram according to an embodiment. Referring to FIG. 7, the user swipes on the interactive graphical interface 23, and this input correspondingly effects to cut off the rope so the purpose of the trial use is achieved.

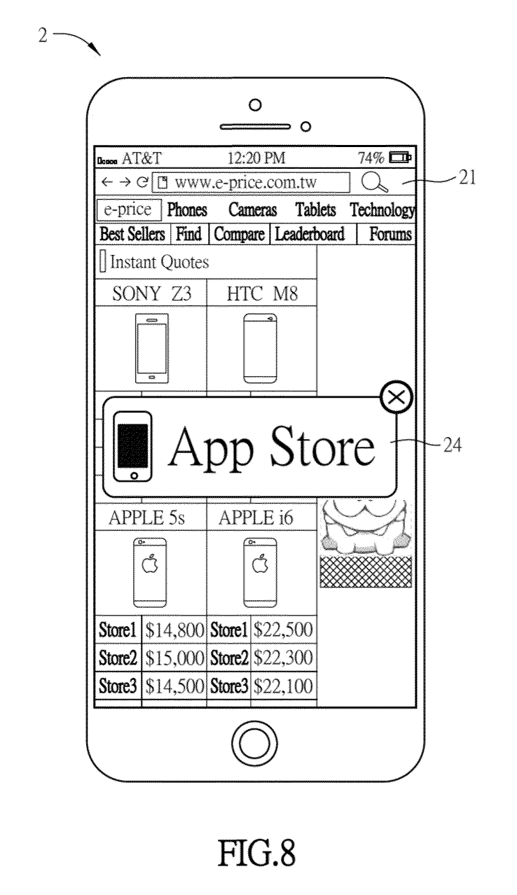

Referring to FIG. 8, it is a schematic situation diagram according to an embodiment. After finishing the trial use, the user device 2 is loaded with a software download data and displays a download page 24 where a link is provided for the user to a page for downloading the application software or to immediately download the application software if the user touches the link. If the user do not want the download, he may close the download page 24 and then the user device 2 is reverted to the status prior to the trial use. Thus, the user may continue to deal with his unfinished affair for example querying data by operating the browser originally prior to the trial use.

In other examples in the embodiment, the server 3b (please also refer to FIG. 4) may confirm the trial environment of the user device 2 before executing the application software. The trial environment includes for example but not limited to device hardware capability and/or network connection status. There at least two possible manners of confirming the trial environment of the user device 2. For example, after receiving the request data, the server 3b sends a query data to the user device to ask the user device 2 to provide data about its current hardware environment and/or connection status; alternatively, data about the hardware environment and/or connection status of the user device 2 are included in the request data and sent together, and they are analyzed by the server 3b. Since the server 3b knows the trial environment of the user device 2, it can decide whether the application software should be executed for the trial use for the user. If the trial environment is not qualified, the server sends an exceptional data to the user device 2 to report that the trial use is currently not available. This avoids bad trial experience of the user due to inferior trial environment.

In other examples in the embodiment, before executing the application software, the server may confirm the state of the application software stored in the memory unit 31b. If the application software has broken or not been stored, the server similarly sends an exceptional data to the user device 2 to report that the trial use is currently not available.

Besides, the advertisement object 22 may be displayed on the lower portion of the page of the application program which is executing, or displayed on the pop-up advertisement. The user may touch the advertisement object 22 in the lower portion of the page or the pop-up advertisement when the native application program is executed. The native application program is a local application software which directly runs on the user device and possibly utilizes various resources of the user device such as camera, GPS, etc. so it has faster executing speed and optimized performance and it can be executed and operated in the offline state. In executing, because the native application program is embedded into the advertisement object 22, the user is oriented for example to try the application software of the related company if the user touches the advertisement object 22. For example, as long as the download page of the application software is closed, the native application program still keeps executed instead of interrupted due to the trial use.

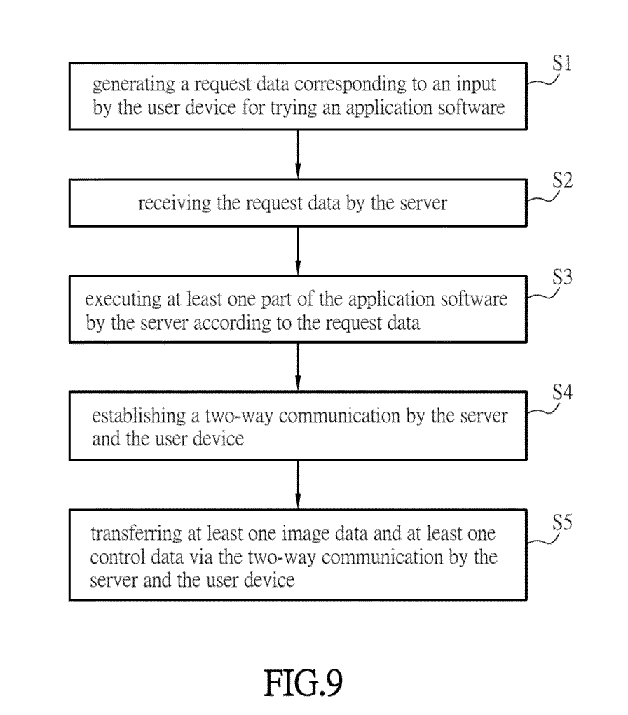

A method of trying application software is also disclosed, and the method is applied to the system for trial use of application software. The system for trial use of application software comprises at least one user device and a server. The server is communicatively coupled to the user device. FIG. 9 is a flow chart of the method of trying application software according to an embodiment. Referring to FIG. 9, the method comprises steps of: generating a request data corresponding to an input by the user device for trying an application software (S1); receiving the request data by the server (S2); executing at least one part of the application software by the server according to the request data (S3); establishing a two-way communication by the server and the user device (S4); and transferring at least one image data and at least one control data via the two-way communication by the server and the user device (S5).

A server applied to a system for trial use of application software is also disclosed. The system for trial use of application software comprises the server and at least one user device. The server is communicatively coupled to the user device. The server comprises at least one memory unit, at least one transmitting unit and one or more than one computing unit. On or more than one computing unit are respectively communicatively coupled to the memory unit and the transmitting unit. The transmitting unit receives a request data, and the request data is generated corresponding to an input on the user device. The computing unit executes at least one part of the application software stored in the memory unit according to the request data and establishes a two-way communication with the user device by the transmitting unit. The server and the user device transfer at least one image data and at least one control data via the two-way communication.

A user device is also disclosed. It is applied to a system for trial use of application software. The system for trial use of application software comprises a server and the user device. The server is communicatively coupled to the user device. The user device comprises at least one memory unit and one or more than one computing unit. The memory unit coupled to one or more than one computing unit stores a plurality of instructions. The computing unit executes the instructions for: receiving an input; sending a request data for trying an application software to the server according to the input; establishing a two-way communication with the server; and transferring at least one image data and at least one control data via the two-way communication with the server. The image data is generated by the server executing one part of the application software, and the control data is provided for the interaction with the application software.

Because the implementation and explanation of the trial method, the server and the user device can refer to the previous description, they are not repeated here.

As mentioned above, as to the system, the method, the server, the user device for trial use of application software, because the application software is executed on the server and it with the user device transfer the screen image and the control action via network, trial use is done on the user's own device under the condition that it is not necessary for the user to download or install the application software or even the trail software. Thus, the doubt about cost is solved, and the hardware resource avoids unnecessary waste. Because download or installation are not necessary and unnecessary operation steps and download time are also reduced, the trial manner of the disclosure is better than traditional trial software. Accordingly, the user may be more possibly willing to try, and advertisement or sell may contribute to better results.

In addition, since the application software is executed on the server, trial use is smoothly done by the user without the hardware limitation of the user device. For example, as to the major application software such as game software which generally requires high performance hardware, this topic is solved by the disclosure.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system for trial use of application software, comprising:
at least one user device; and
a server, communicatively coupled to the user device;
wherein the server receives a request data for trying an application software, the request data is generated corresponding to an input on the user device, the server executes at least one part of the application software according to the request data and establishes a two-way communication with the user device, and the server and the user device transmits at least one image data and at least one control data via the two-way communication.

2. The system according to claim 1, wherein the server comprises at least one cluster computing unit, the cluster computing unit comprises at least one cluster node, and the server executes the application software by the cluster node.

3. The system according to claim 2, wherein the cluster node comprises at least one virtual machine, and the server executes the application software by the virtual machine.

4. The system according to claim 3, wherein the virtual machine executes an operating system corresponding to the application software, and executes the application software on the operating system.

5. The system according to claim 3, further comprising another user device, wherein the server receives another request data for trying another application software, another request data is generated corresponding to an input on another user device, and the server executes another application software on the same virtual machine according to another request data.

6. The system according to claim 3, wherein the virtual machine executes an I/O agent to transfer data to the user device via the two-way communication.

7. The system according to claim 1, wherein the server comprises a memory unit storing a snapshot data of which the state is that the server executes the application software.

8. The system according to claim 1, wherein the server comprises an application program interface unit, a service session manager and a resource pool manager, the application program interface unit receives the request data, the service session manager generates a service session data according to the request data, the resource pool manager obtains/generates a data related to the execution of the application software according to the service session data, and the server executes the application software according to the data related to the execution of the application software.

9. A server applied to a system for trial use of application software, wherein the system comprises the server and at least one user device, the server is communicatively coupled to the user device, the server comprising:
at least one memory unit;
at least one transmitting unit; and
one or more than one computing unit, respectively communicatively coupled to the memory unit and the transmitting unit, wherein the transmitting unit receives a request data, the request data is generated corresponding to an input on the user device, the computing unit executes at least one part of the application software stored in the memory unit according to the request data and establishes a two-way communication with the user device by the transmitting unit, and the server and the user device transfer at least one image data and at least one control data via the two-way communication.

10. The server according to claim 9, further comprising at least one cluster computing unit, wherein the cluster computing unit comprises at least one cluster node, and the server executes the application software by the cluster node.

11. The server according to claim 10, wherein the cluster node comprises at least one virtual machine, and the server executes the application software by the virtual machine.

12. The server according to claim 11, wherein the virtual machine executes an operating system corresponding to the application software, and executes the application software on the operating system.

13. The server according to claim 11, wherein the server receives another request data for trying another application software, another request data is generated corresponding to an input on another user device, and the server executes another application software on the same virtual machine according to another request data.

14. The server according to claim 11, wherein the virtual machine executes an I/O agent to transfer data to the user device via the two-way communication.

15. The server according to claim 9, wherein the memory unit stores a snapshot data of which the state is that the server executes the application software.

16. The server according to claim 9, further comprising an application program interface unit, a service session manager and a resource pool manager, wherein the application program interface unit receives the request data, the service session manager generates a service session data according to the request data, the resource pool manager obtains/generates a data related to the execution of the application software according to the service session data, and the server executes the application software according to the data related to the execution of the application software.

17. A method of trying application software applied to a system for trial use of application software, wherein the system comprises at least one user device and a server, and the server is communicatively coupled to the user device, the method comprising:
generating a request data corresponding to an input by the user device for trying an application software;
receiving the request data by the server;
executing at least one part of the application software by the server according to the request data;
establishing a two-way communication by the server and the user device; and
transferring at least one image data and at least one control data via the two-way communication by the server and the user device.

18. The method according to claim 17, comprising:
confirming the trial environment of the user device by the server before executing at least one part of the application software.

19. The method according to claim 17, comprising:
confirming the state of the stored application software by the server before executing at least one part of the application software.

20. The method according to claim 17, comprising:
loading an application software download data by the user device after the transfer of the image data is ended.
